(19) United States
(12) Patent Application Publication
(10) Pub. No.: US 2013/0163370 A1
(43) Pub. Date: Jun. 27, 2013

(54) Mixing Device

(71) Applicants: Brian C. Shaifer, Miami, FL (US); Simon E. Arenas, Miami, FL (US)

(72) Inventors: Brian C. Shaifer, Miami, FL (US); Simon E. Arenas, Miami, FL (US)

(73) Assignee: Bacardi & Company Limited - Corporation Liechtenstein, Vaduz (LI)

(21) Appl. No.: 13/821,062

(22) PCT Filed: Sep. 14, 2011
(86) PCT No.: PCT/US2011/051494

§ 371 Date: Mar. 6, 2013

Related U.S. Application Data
(60) Provisional application No. 61/383,272, filed on Sep. 15, 2010.

(51) Int. Cl. A47J 43/27

(52) U.S. Cl. CPC A47J 43/27
USPC 366/130

(57) ABSTRACT

A device for mixing liquid preparations.

### CROSS REFERENCE TO RELATED APPLICATIONS

This application claims the benefit of priority of U.S. Provisional Application 61/383,272 filed Sep. 15, 2010 and incorporated herein by reference in its entirety.

### BACKGROUND

The present invention generally relates to a mixing device vessel for preparing mixed concoctions, such as cocktail beverages.

Concoctions can be prepared in a multitude of fashions. In a cocktail beverage, various culinary fruits and vegetables or an extraction of their constituent parts can be added as an ingredient along with alcohol to form a concoction having a unique flavor. Extractions of the constituent parts may include: solids, such as the rind; semi-solids, such as the pulp; liquids, extracted from the pulp; or essence, extracted from the rind. Combining these or other ingredients to prepare the concoction may involve a shaker, wherein the ingredients are combined into a tall vessel onto which a lid is placed. The closed vessel is shaken to thoroughly mix the ingredients and the concoction served.

Various “shakers” exist in the art. U.S. Pat. No. 2,030,834 to Cominsky describes a shaker for cocktails and other liquid refreshments, comprising a shaker body of vitreous or other fragile material, said shaker body being provided with locking means adjacent its mouth, and closure means for the mouth of the shaker body, said closure means including a cap member of vitreous or other fragile material fitting within and around the top of said shaker body, said closure means further including a casing member displacingly enclosing said cap member, resilient means interposed between said cap member and said casing member and locking means carried by said closure means cooperating with said locking means of said shaker body, said locking means carried by said closure means including peripherally spaced elements respectively cooperating with said locking means of the shaker body and loosely engaging said cap member peripherally and at its lower edge, whereby the cap member and its interposed resilient means are retained as a unit within the casing member of the closure means upon removal of the closure means from the shaker body.

U.S. Pat. No. 6,913,165 to Linz et al. describes a cocktail shaker which has a head adapted for releasably sealing an insulated container, having at least one plastic wall, where the container may be used as a drinking vessel. The shaker comprises a shaker top consisting of a dome portion, the dome portion having an opening at one end for pouring mixed drinks from the shaker, and a separate cylindrical portion secured to said dome portion remote from said one end opening, said cylindrical portion having a stepped portion for receiving said dome portion thereover and a channel on the periphery of said cylindrical portion; and a container for receiving drink materials for mixing, said container consisting of spaced apart insulating wails, and a smooth circumferential lip bridging and securing said walls together; and a sealing gasket seated in said peripheral channel, said sealing gasket having flexible ribs extending from said channel adaptable to removably seal said cylindrical portion within said container when said top is installed within said container.

U.S. Pat. No. 7,571,830 to Lin describes a beverage shaker consisting of an insulated container which is configured to hold the ingredients for protein supplement drinks, permitting manual mixing by shaking to and fro and retains any large pieces of the remaining ice with the container. The shaker has a removable top member that is attached to the container which includes a smooth peripheral lip surrounding the container suitable for drinking. A strainer is supported internally by the top member and is configured for holding back large sized pieces of ice. A lid internally interfaces with the top member in a leak proof manner permitting protein supplement drink ingredients to be mixed and consumed directly from the shaker when the lid is removed.

U.S. Patent Application Publication 2009/0120932 to McLaughlin describes drink ingredients being placed in a mixing container, wherein a cap is placed on top of the mixing container. The cap comprises a closed end connected with an annular open end by a surface, and has a perimeter located at the junction between the annulus and the surface. The annular open end contains perforations formed by holes or fingers that fit inside the rim of the mixing container, with the rim of the mixing container in continuous contact with the perimeter. The drink is poured and filtered by slightly lifting and tilting the cap to allow gravity to pull the liquid through the perforations, thereby filtering the drink and eliminating the need for a separate filter.

There is currently no device having impinging protrusions for preparing a mixed beverage, wherein the protrusions are within the confines of the beverage containing space of the container and capable of extracting portions of an additive, such as fruit pulp or essence to a liquid collocated in the container. To aide in the reduction of the number of devices needed for preparing mixed concoctions, such as beverages and the like, there exists a need to more simply extract portions of additive ingredients overcoming all the shortcomings of current devices used to prepare a mixed concoction.

### SUMMARY OF THE INVENTION

The present invention generally relates to mixing device vessels for mixing solids and liquids to form a liquid preparation. Such vessels are useful for preparing beverages, such as cocktail beverages. Although the following embodiments describe an exemplar mixing device for the preparation of a cocktail beverage, the various embodiments herein can also be used for the preparation of pharmaceutical products, other food concoctions or preparations involving mixing of solids or portions thereof with liquids.

With respect to cocktail beverages, solids, such as fruit, can be a added to a preparation to impart additional flavors or to enhance the taste. Generally, although not exclusively, portions of one or more fruit solids, liquid extracted from the fruit(s) or the essence of the fruit(s) can be combined with one or more liquids to accomplish the taste enhancement. In various embodiments herein, the solid(s) are placed in the lower portion of the vessel, over which liquids may be added. The vessel, having an upper portion and a lower portion, the upper portion acting as a lid, cap or plug, mateably seals with the lower portion and the container shaken, thereby, disturbing and distributing the contents of the container causing the contents to be broken down into smaller portions, the liquids extracted, or the essence obtained and transferred into the liquid. Additional liquids can be added to the preparation and the contents can be strained into a consumption receiver, such as a cup or glass. Straining the contents may be performed by separating the upper and lower portions to reveal a variable opening from which the liquids can be dispense while retaining the solids in the vessel.

It is an object of the present invention to provide a novel vessel having internal protrusions unto which added solids may impinge during shaking, thereby releasing portions of the solid for combining with a liquid preparation, or the liquid or essences derived from the impingement of the fluids and/or solids are suitable, or substantially mixed to the consumer's taste.

In one embodiment the vessel has an upper portion (cap) and lower portion (container). The cap and container may be nearly equal in size, or sufficiently different. The cap and container may be generally cylindrical in nature with rounded edges, but other shapes can be used, such as a modified or substantially conical shape. The cap and container may have a defined surface opposite their respective rims such that each may rest upright on a level surface with the cavity facing up. The cap, having a smaller diameter rim than the container, fits into the container, such that the cap rim and outer surface proximal to said rim seal around the container wall inner surface preventing the contents from escaping and enclosing a volume nearly the union of the two separate volumes.

In an alternative embodiment, the cap may fit over the container. The container, having a smaller diameter rim than the cap, fits into the cap, such that the container rim and outer surface proximal to said rim seal around the cap wall inner surface preventing the contents from escaping.

Material for the shaker can be of various common materials such as metal, plastics, glass, and the like, or more exotic materials. Metal may be formed by processes such as casting, milling, pressing or spin forming. Plastic can be cast, injection molded, spun molded or milled, and glass can be formed by casting, blowing and various other methods.

Further to the present embodiment, the container may be formed having an internal protrusion of the bottom surface extending into the volume defined by the inner walls and the rim, and occupying a portion of the volume.

In one embodiment there exist a mixing device comprising a seperable upper portion having a closed end connected to an annular opening by a conical to nearly cylindrical side surface defining a cavity; a lower portion having a closed end connected to an annular opening by a conical to nearly cylindrical side surface defining a cavity and configured to mateably seal to said upper portion generally about their annular openings, said lower portion comprising a substantially large protrusion extending from said closed end into said lower portion cavity and operatively configured to impinge one or more ingredients added thereto. The device may further comprise an ingredient facing surface having a plurality of protrusions dispersed within the cavity and may have the protrusion as an insert. The device may also have the protrusions and the plurality of protrusions formed as or on an insert and the device may have the upper portion comprising a protrusion extending from said closed end into said cavity. The device may also have the upper portion protrusion and lower portion protrusion operatively configured to mutually impinge one or more ingredients when the upper portion and lower portion are joined. The device may alternatively have a lower portion having a grip surround axially about the outer surface extending from proximal to the annular opening of the lower portion to the mid-section.

In another embodiment there is a method of preparing a concoction in a mixing device comprising adding ingredients to a lower portion of said mixing device, said lower portion having one or more protrusions; joining a mating upper portion operatively forming a seal with said lower portion; shaking said mixing device, impinging one or more of said ingredients on said one or more protrusions; and imparting said at least a portion of said one or more of said ingredients into said concoction.

In another embodiment there exists a mixing device comprising a seperable lower portion comprising a closed end connected to a rimmed opening by a conical to nearly cylindrical side surface defining a cavity, said lower portion comprising a protrusion extending from said closed end into said lower portion cavity; an upper portion comprising a closed end connected to a rimmed opening by a contoured conical side surface defining a cavity and configured to mateably seal with said rimmed opening of said lower portion, said upper portion side surface extending distal to said closed end, beyond whereabout said upper and lower portions mateably seal, and having a side surface interior diameter minimally larger than said lower portion rimmed opening. The device may further comprise an ingredient facing surface comprising a plurality of generally small protrusions dispersed within each cavity. The device may also have said plurality of generally small protrusions formed by an insert, inserted or formed into each cavity. The device may optionally be a beverage mixing device. The exterior surface of the upper portion closed end of the device may optional be relatively flat and the rim height relative to said a closed end may vary in a periodic manner about the circumference.

Further to the above present embodiment, the mixing device upper portion may comprise a sealing member affixed to the interior surface of the upper portion and configured in size to mate with said rim of said lower portion. The device rim of the lower portion may optionally seal against the inner surface of the upper portion, or comprise a molded hand grip incorporated into said upper or lower portion. The device may optionally provide that the rim of the lower portion seals against the edge of the insert of the upper portion if the upper portion makes use of such an insert as described. The device as described with a varied and periodic rim height may have the rim height as substantially sinusoidal relative to the closed end of the upper portion.

The embodiment currently described may also exhibit an upper portion having a midsection with molded-in features substantially similar to that of the varied rim, or where a partially separated upper and lower portions reveal a geometric shape, such as a generally triangulated opening, from which the liquid portion of a prepared beverage is dispensed.

### BRIEF DESCRIPTION OF THE DRAWINGS

FIG. 1 is a pictorial depiction of a mixing device vessel lower portion having a grip surround.

FIG. 2 is a pictorial depiction of a mixing device vessel having an upper and lower portion which fit together forming a seal to contain ingredients during shaking and preparation of a mixed concoction and further having a surface of regular protrusions formed by an insert in the lower portion.

FIG. 3 is a further cut-away pictorial depiction of a mixing device vessel having an upper and lower portion which fit together forming a seal to contain ingredients during shaking and preparation of a mixed concoction and further having respective inserts in the upper and lower portions, the lower portion also having a central protrusion in the concoction cavity formed by the insert.

FIG. 4 is a front perspective pictorial depiction of a mixing device vessel having a separated upper and lower portion which fit together forming a seal to contain ingredients during shaking and preparation of a mixed concoction and further having a molded exterior.

FIG. 5 is a front view pictorial depiction of a mixing device vessel having a separated upper and lower portion which fit together forming a seal to contain ingredients during shaking and preparation of a mixed concoction and further having a molded exterior.

FIG. 6 is a side view pictorial depiction of a mixing device vessel having a mated upper and lower portion which fit together forming a seal to contain ingredients during shaking and preparation of a mixed concoction and further having a molded exterior.

FIG. 7 is a front view pictorial depiction of a mixing device vessel having a mated upper and lower portion which fit together forming a seal to contain ingredients during shaking and preparation of a mixed concoction and further having a molded exterior.

FIG. 8 is a top view pictorial depiction of a mixing device vessel lower portion having a centrally located, substantially large, protrusion extending from the closed end of the cavity and further having an ingredient facing surface comprising a plurality of generally small protrusions dispersed within the cavity.

FIG. 9 is a bottom view pictorial depiction of a mixing device vessel upper portion having an ingredient facing surface comprising a plurality of generally small protrusions dispersed within the cavity.

### DETAILED DESCRIPTION OF THE INVENTION

Mixed concoctions often require introduction of ingredients that may require some form of breakdown, such as pulverizing or crushing. Pulverizing ingredients, such as fruits for use in a cocktail beverages result in added time, utensils, and space to prepare the concoction as well as time necessary to maintain the area and equipment used for such purpose.

There is provided herein a device for preparing a mixed concoction, such as a cocktail beverage. The present device allows for quick and clean preparation of a concoction by extracting substances, or portions thereof, from ingredients through their impingement on one or more interior surface protrusions built into the shaking vessel, imparting flavor and/or aroma to the concoction from ingredients, such as fruit. As will be shown by the various embodiments, the vessel may be shaken to repeatedly impinge one or more ingredients on the protrusion(s) or the one or more ingredients may be squeezed or crushed by opposing impinging protrusions.

In one embodiment, the mixing device is a vessel having a separable upper cap portion that mates with a lower container portion thereby forming a sealable internal cavity when joined, such that contents within the vessel cavity may be shaken to mix the contents without loss of the contents. Both the container and cap have an open annular end and a closed end connected by a conical, cylindrical, or nearly conical surface. The open end of each container and cap is further defined by a perimeter at the open annular end. A seal may be formed by mating the two annular portions of the container and cap, forming a seal about the perimeter of the annular openings. The annular open end of the upper cap portion may be sufficiently small to fit within the internal diameter of the annular open end of the container portion, having the closed ends of the cap and container distil to one another, and the annular perimeter of the cap forming a seal around the inner perimeter of the container cavity wall proximal to the container's annular opening.

In an alternative embodiment, the cap may fit over the container. The container, having a smaller diameter rim than the cap, fits into the cap, such that the container rim and outer surface proximal to said rim seal around the cap wall inner surface preventing the contents from escaping. The cap rim may extend beyond the point or location providing a seal, such that the joint of the two may be hidden from view. The inner diameter of the cap from the rim to the point of seal may be of minimally larger diameter than the rim of the container. The inner diameter of cap from the rim to the point of sealing may, in alternative embodiments, be minimally larger that the coinciding portion of the container such that the diameter varies accordingly. Such would be the case if the outer diameter of the container lessens from some maximum diameter to the rim.

The extended rim of the cap may vary in height relative to the closed end or relative to the location of seal, and relative to the perimeter. The variation in rim height may or may not be periodic, such that the shape of the edge changes in a repeating pattern. The pattern may be triangular or sinusoidal or some other geometric variant.

The pattern of the rim may also be substantially repeated in the exterior shape of other constituent parts of either the cap or the container. The cap, for example may exhibit features in the mid-section, or proximal thereto, resembling the change in height in the rim in a corresponding fashion.

The cap may have a sealing member disposed within the interior perimeter of the cap at a predetermined distance from the closed end or perimeter such that effective sealing may be accomplished. The seal may be formed into the interior perimeter, adhered to the interior perimeter, or insert by one of various means such as insert molding, pressing or the like. The seal has a generally constant annular and distal location, such that it coincides with the shape of the contain rim to provide a mateable seal with the container. It is envisioned that a sealable member might be formed within the cap to accommodate a container rim that is not annular or such that the seal is a constant distance from the closed end. A seal may be formed from rubber, silicone, plastic or some other suitably soft material consistent with the materials being prepared.

A mateable seal, or mateably sealing is defined as providing a seal between the upper portion and lower portion when mated, wherein each closed end is distal to each other, thus forming a combined cavity and the contents are prevented from escaping.

The vessel may be constructed from any solid, relatively ridge material, such as glass, metal, plastic, composite or some other non-limiting suitable material. The vessel may further be constructed of a combination of materials, such as metal with plastic inserts and soft rubber surrounds. The cap may be constructed of the same materials in the same fashion as the container or be constructed in an alternative fashion, such that the container and cap might perform different functions. The vessel may be a single or multi-walled vessel. The vessel may also be constructed to have multiple layers, of the same or differing materials, such that each is operatively configured to serve a different purpose in manufacture and/or use.

In one embodiment, the closed end of the container comprises a protrusion extending into the vessel cavity. The protrusion may be press-formed by depression of the bottom, or closed end, of the container into the cavity, such as by stamping. The protrusion may be small, consuming little of the cavity volume, or may be large, consuming a considerable portion of the cavity volume. The protrusion may be conical, cylindrical, flat, pyramidal or any number of shapes.

In a further embodiment, the container protrusion may be added to the interior portion of the closed end of the container by joining pieces during manufacturing by means of a connection such as bonding, adhering, welding, latching or threading (or the like). The protrusion may also form the entirety of the closed end or be a part, or feature, of the piece that forms the closed end to which the annular open end is connected by the conical, cylindrical or nearly conical side surface.

In one embodiment, the protrusion is selectable as an insert and may be removed and/or replaced. The protrusion insert is installed from the interior side and locked into position to the closed end of the container by a locking ring, an interference fit with or without tabs, or mating feature formed in the material of the closed end.

In an alternative embodiment, the insert may also be installed into a through hole in the otherwise closed end of the container distal to the annular open end. The protrusion insert may be inserted via the exterior side or the interior side and suitable sealed and locked into position so as to prevent escape of any ingredients. Locking means may comprise threads, twist-locks, locking rings or the like. Seals may be formed from O-rings, flat washer shapes or other known means. Various insert shapes can be made and swapped out as replaceable inserts. Shapes may be interchanged such that a small protrusion may be removed in favor a larger one, or one having a shape not substantially conical. Shapes may be categorized and deemed best for certain functions, such as extracting essence, verses extracting rind.

In one embodiment, the protrusion may have further secondary protrusions of finer or smaller detail on the interior wall of the ingredient facing surface. These secondary protrusions or surface treatment may comprise pyramidal, semi-spherical, conical, cylindrical, or other shapes and may cover a substantial portion of the primary protrusion. Coverage may exist near or at the tip distal to the closed end, in the middle or at the bottom of the primary protrusion, proximal to the closed end and distal to the annular open end of the container. The secondary protrusion shapes may be regular in their arrangement or irregular and may be combined with various other shapes. The secondary protrusions may be oriented to face substantially into the vessel cavity, reducing it's volume, or negatively oriented, such that they might add to the volume.

Alternatively the container may be formed such that the interior, or inner, wall of the conical to nearly cylindrical side surface connecting the open end with the closed end of the container exhibits one or more secondary protrusions, equivalent or nearly equivalent to those described above. The side surface material may be substantially thick enough, such as if made from plastic to have a differing interior surface finish than the exterior surface. The container may again be a dual walled container such that the inner and outer side surfaces connecting the annular open end and the closed end have different surface textures. The exterior wall may be formed such that the closed end, or bottom, is flat to allow the container to suitably rest on a table surface with the open end facing upward.

The protrusions of the container may be formed by an insert comprising the central protrusion and the secondary protrusions. The central protrusion may form the bottom, or closed end of the insert and be joined to an annular opening by a conical to nearly cylindrical wall. The insert may be manufactured as a one piece injection molded part or as multiple parts combined in the container at a later time. The insert may be operatively configured to be insert molded into an existing container or created to match a known container and mated at a later time.

In one embodiment, the vessel container having a protrusion extending into the vessel cavity and connected to the closed end of the container is formed having a cavity filled with a heat transfer medium and sealed. The protrusion may have in concert with the filled cavity, secondary protrusions to impart the greatest rate of heat transfer in the given time a shaker is used to mix ingredients. The heat-transfer medium may be used to cool the concoction or alternatively heat the concoction. The container may be stored in a relatively cool or hot local until needed. As previously described the protrusion may be a replaceable insert and alone may be stored in a relatively cool place, such as a freezer, or in a relatively hot place like a warming tray or holder.

In an alternative embodiment, the protrusion may be hollow and accessible from an exterior part of the closed end of the vessel. A formed insert, matching the interior dimensions of the hollow cavity of the protrusion and containing a heat transfer medium may be replaceably inserted and locked into position, or removed. Insert and locking means may be performed and configured as previously described above and as are described below.

In one embodiment, the upper portion cap has an annular open end and closed end, the closed end having one or more protrusions across the surface facing inward toward the vessel cavity. The protrusions may be of various shapes comprising pyramidal shapes, conical shapes, semi-spherical shapes, or the like. The shapes may be substantially flat relative to one another or varied in their size, shape, and type. The one or more protrusions may be placed in a geometric pattern or dispersed in an irregular arrangement, or at least appear to be irregular in their arrangement.

In an alternative embodiment, the upper portion cap has a protrusion extending from the closed end directed inward toward the vessel cavity. The upper cap protrusion can extend outward proximal to an opposing protrusion extending from the container into the vessel cavity, such that the two protrusions are operatively configured to form a mutual impingement point when both portions are brought together. The mutual impingement point may be used to hold predetermined ingredients, such as a piece or portion of fruit, or crush the ingredient during the joining process. In this way the liquid ingredients are added and the selected ingredient to be impinged is placed on one protrusion and during joining of the opposing portion is held or crushed imparting pieces or portions of the ingredient to the others.

In one embodiment, the inner portion(s) of the vessel coming into contact with the ingredients to be mixed may be formed of plastic and bonded to an intermediate layer composed of metal, such as 18/8 stainless steel. The bond may be formed by hot insert molding of the plastic into the metal or formed by the use of a suitable adhesive. The plastic insert(s) may exhibit a central protrusion and secondary smaller protrusions across the ingredient contacting surface. The insert may or may not be removable and may be formed to be added to pre-existing mixing devices of matched shape and combined at a later time. The vessel may further have incorporated onto the outward surface of the metal intermediate layer an insulating layer, such as rubber, forming a gripping surface and minimizing the heat transfer between the user and the vessel.

In another embodiment the upper and lower portions may comprise double walls having inner and outer materials/layers, such that the two materials are spaced apart to create a cavity between them. The cavity can be filled with solid insulating materials, or evacuated and sealed to provide a vacuum chamber. The rims of the two walls may joined dependent on the material of use. The two walls of the lower portion may comprise an inner semi-cylinder and an outer semi-cylinder. The inner lower portion may have a plurality of protrusions extending into the cavity into which the beverage ingredients as previously described.

The upper portion and lower portion of the shaker can be vacuum formed to create an inner and outer surface distal from each other and having different textures, such that the interior surface is patterned. In one embodiment the inner surface is a pyramidal form and the outer surface is smooth or semi-smooth, such as with brushed stainless steel.

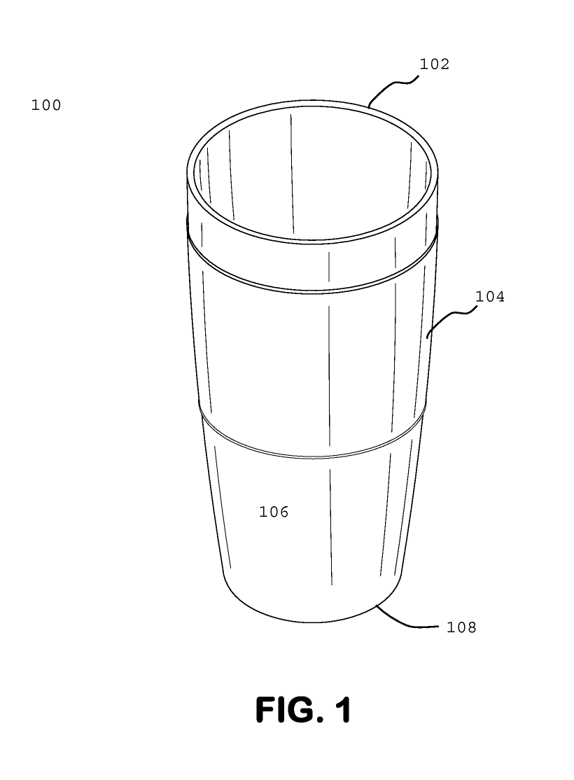

In FIG. 1, there is shown an exemplar mixing device lower container 100 having a grip 104 surrounding the outer surface of the container extending from proximal to the annular opening 102 down to approximately the mid section. The grip 104 may, in alternative arrangements, extend from nearly the annular opening 102 to the bottom of the surface connecting the annular opening to the closed end 108, or surround the exterior surface of the container 100 entirely. The grip 104 may be composed of a rubber ring, foam, or other suitable material or application method such as spray painting a surface treatment such as rubberized paint. The main body 106 may be constructed from a relatively rigid, yet durable material, such as metal or plastic.

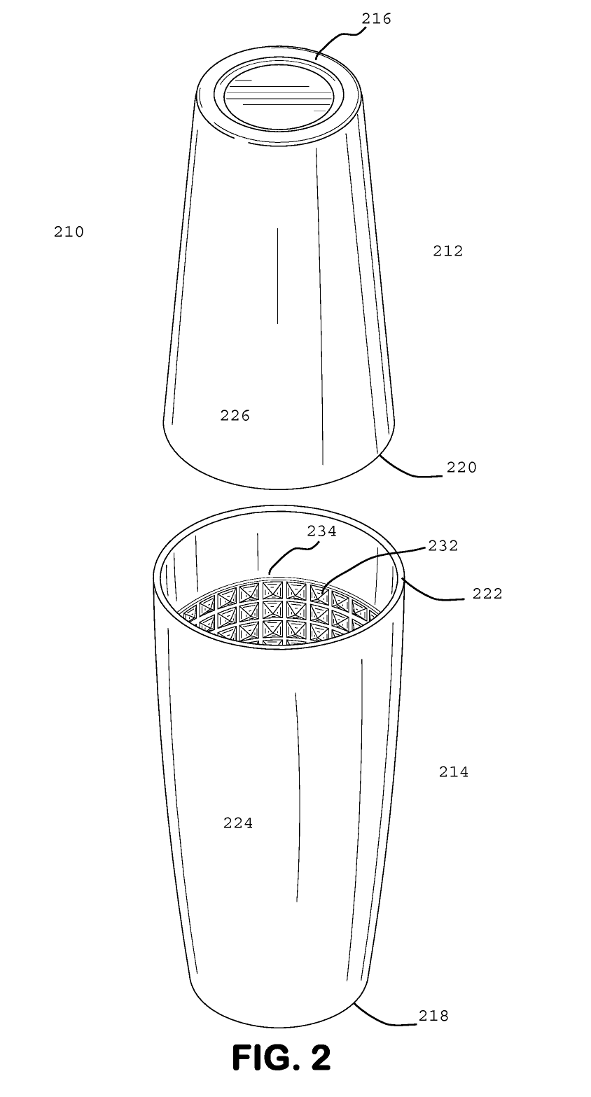

Turning to FIG. 2, there is shown an exemplary mixing device vessel 210 having an upper portion cap 212 and a lower portion container 214, each portion have a main body 224 and 226 respectively, and each formed with a closed end 216 and 218 respectively, connected to an open annular end 220 and 222 respectively, by a semi-conical, to nearly cylindrical side surface. The main bodies 224 and 226 may be constructed from a relatively rigid material, such as metal. The container has an insert 234 bonded to the inner wall of the container body 224 having surface protrusions 232 arranged in a regular pattern and composed of a regular geometric shape. The insert extends into the contain body cavity from proximal to the annular opening 222 down the inner wall.

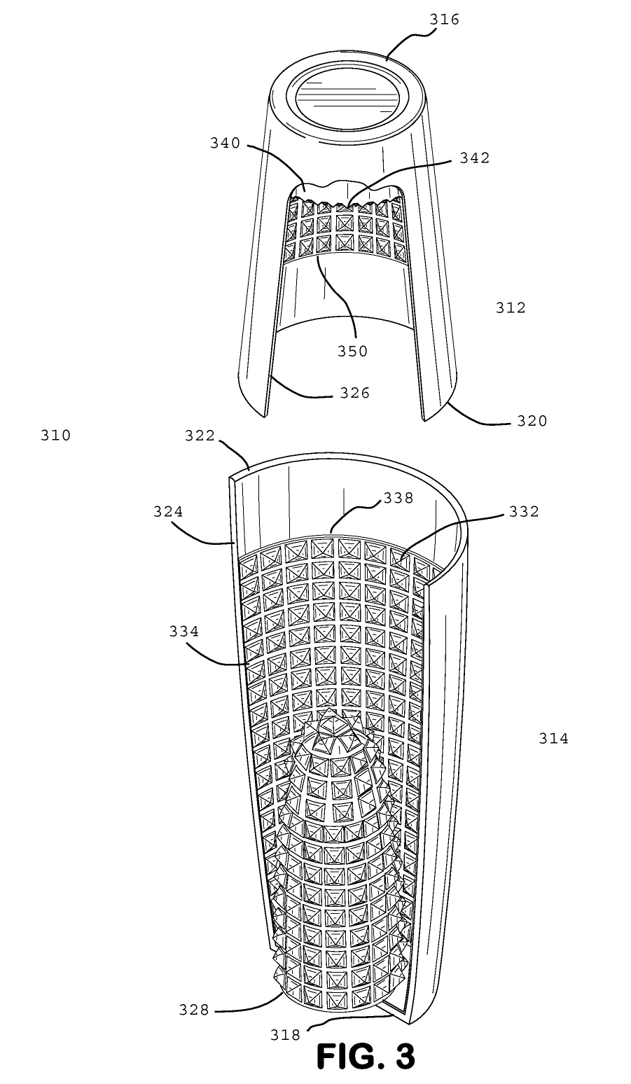

Turning to FIG. 3, there is disclosed an embodiment of a mixing device having one or more alternative features. The container body 324 has bonded into its interior cavity a plastic insert 334 extending from the closed end 318 up along the inner wall of the contain body 324 and terminating proximal to the open annular end 322. Molded (or bonded) into the insert 334 at the closed end is a roughly conical shaped central protrusion 328 narrowing toward the open annular end 322 of the container 314 that can be used to extract substance from an otherwise solid or semi-sold ingredient when the closed vessel is shaken. The ingredient facing surface of the insert 334 may have further geometric secondary protrusions 332 molded in place in a regular or irregular pattern extending from the bottom, or closed end, to nearly to full height of the insert 334, approaching the annular opening 338 end of the insert 334. The secondary protrusions 332 may also be incorporated into the surface of the central protrusion 328 and may be regular or irregular and may extend from the bottom, closed end to the tip of the central protrusion 328 or only cover a portion of the surface.

A cavity may be formed (not shown) from the inner body of the central protrusion wherein a heat transfer medium may be located and sealed by capping the cavity or the bonding of insert 334 into the container 324 inner wall.

A sealing surface along the annular opening 338 end of the insert 334 may be formed such that the annular opening 320 of the upper cap 312 may be seated against the sealing surface to form a seal, holding the contents securely into the closed vessel during shaking.

Further to FIG. 3, the upper cap 312, having a cap body 326 exhibits bonded into its interior cavity an insert 342 extending from the cap closed end 316, within the cavity, up the cap inner wall terminating proximal to the annular opening 320. The insert 340 has multiple surface protrusions 350 on the ingredient facing surface extending from the bottom to the rim, or annular opening, of the insert. The closed end, or bottom, of the insert 342 is raised, extending into the cap cavity and has surface protrusions 342 that are of mutually equal height measured from the closed end, or bottom. The surface protrusions are of regularly shaped geometric figures and regularly spaced as shown or alternatively may be irregular in shape and spacing. The insert may exhibit a central primary protrusion similar to that described above for the container 314. An alternative embodiment may have no surface protrusions along the inner wall with the insert limited to the raised closed end.

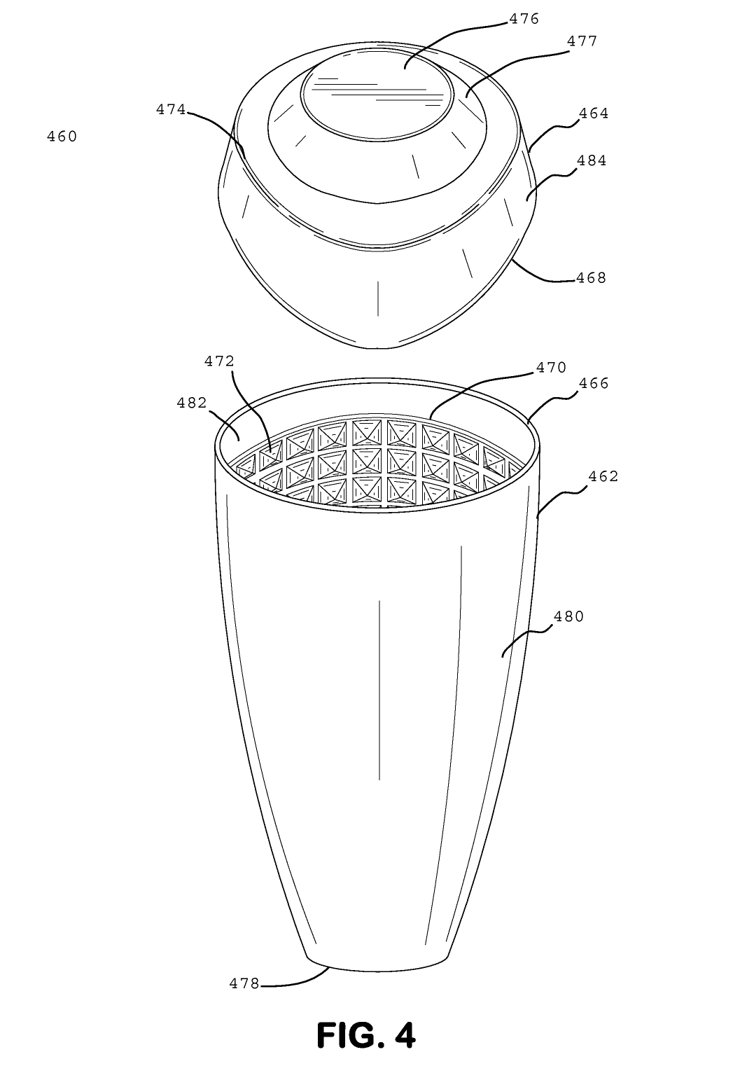

In FIG. 4, there is shown an exemplar mixing device of an alternative embodiment. The mixing device vessel 460 having an upper portion cap 464 and a lower portion container 462, each portion have a main body 484 and 480 respectively, and each formed with a closed end 476 and 478 respectively, connected to an open end 466 and 468 respectively, by a semi-conical, to nearly cylindrical side surface or contoured side surface. The main bodies 480 and 484 may be constructed from a relatively rigid material, such as plastic, and may have one or more surface treatments or textures. The treatments or textures may be distributed about each portion. The exterior portions may exhibit a satin finish while the internal area may be smooth or glossy. The treatment or texture may assist holding the device during shaking or to more easily distinguish the parts in a dark environment. The material may exhibit a retro reflective nature or be photo luminescent. The container 462 has an optional insert 470 bonded, or insert molded, to the inner wall 482 of the container body 480; the insert having a plurality of generally small to modest sized surface protrusions 472 arranged in a regular pattern and composed of a regular geometric shape. The insert 470 extends into the container 462 cavity from proximal to the annular opening 466 down the inner wall and includes a closed end (hidden). The surface protrusions may be alternatively formed in the body materials.

Further to FIG. 4, the cap 464 and container 462 have a substantially flat closed end outer surface 476 and 478 respectively, with the cap further having a sloped feature 477 joined to a molded contour 474 generally matching that of the rim 468. The closed end 478 of the container 462 may be narrow as shown, or broadened to increase stability.

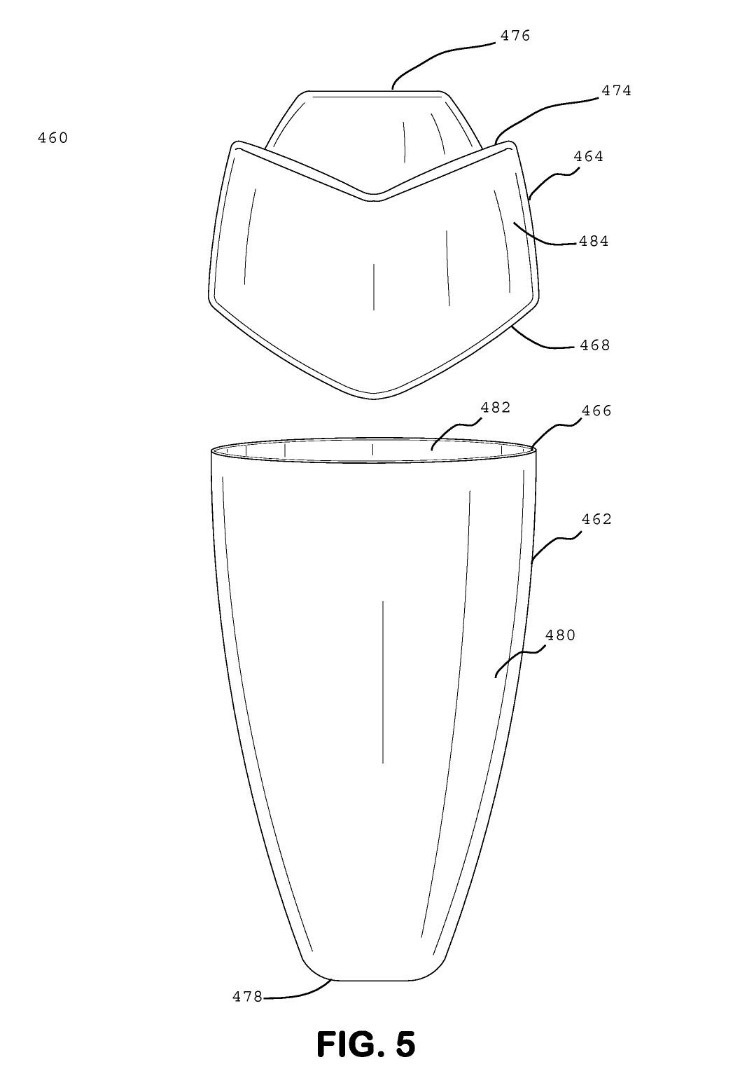

Turning to FIG. 5, the same embodiment of FIG. 4 is shown in a separated view further illustrating the mixing device. The mixing device 460 contours of the cap 464 exhibit a multi-conical shape joined by the conical feature 474. Specifically, the contour feature 74 can be seen to generally resemble that of the rim 468 on the cap 474, which may act as a molded grip for the user to aid in maintaining the mateable seal of the two portions. The constant annular rim 466 of the container 462 is evident as is the inner surface 482.

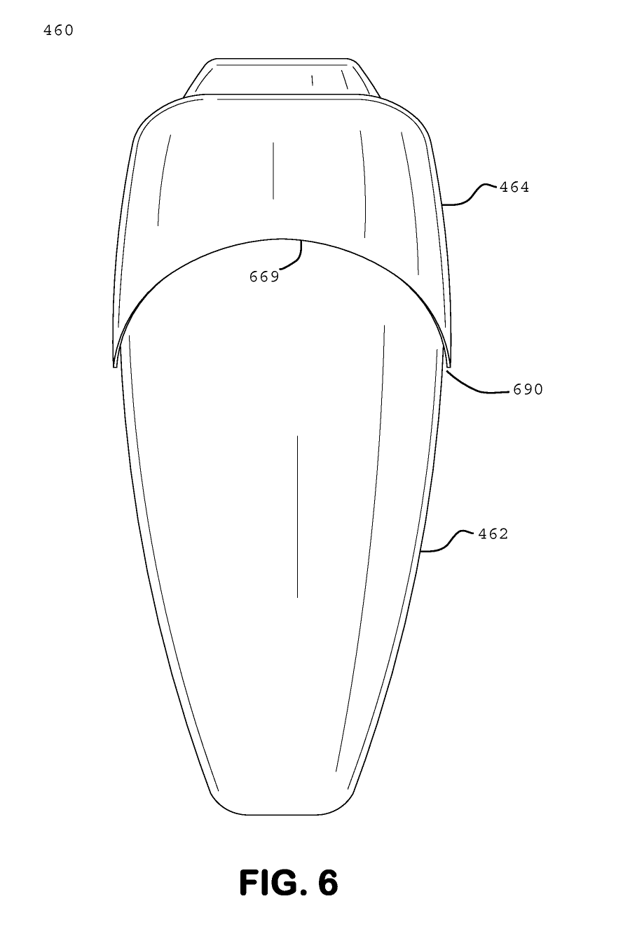

FIG. 6 is a side of the exemplar embodiment shown in FIGS. 4-5, where the upper cap 464 and lower contain 462 portions are mateably sealed. The mixing device 460, specifically the cap 464 has a varying height rim about the perimeter. The overlap 690 of the cap 464 to the container 462 can be seen as is the contour of the rim height 669. The rim 466 of the container 462 is hidden from view by the extended rim 468 of the cap 464. A slight separation of the cap 464 and container 462 would review an opening (not shown) from which the liquid contents may be dispensed while filtering back the solids. In the embodiment shown, the opening would appear to have an straight side and an arched side coinciding with the relative heights or contour of the respective rim perimeters.

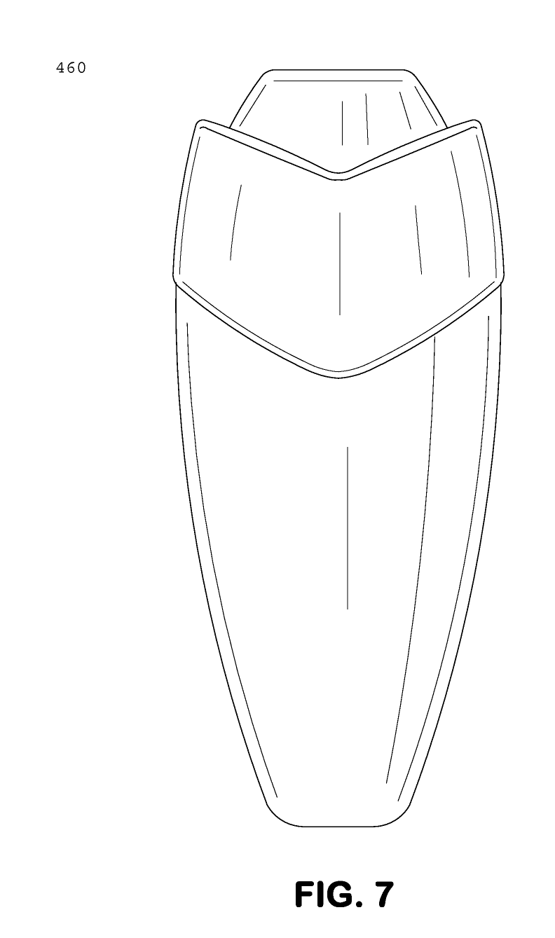

In the embodiment shown in FIG. 6, the rim height is arched in a twice repeated pattern around the perimeter of the cap 460, thus having a similar appearance on the opposing side view. Likewise the front view, as shown in FIG. 7, and rear view are similar. Optionally the front view may further exhibit a logo impressed into the material or applied by known means.

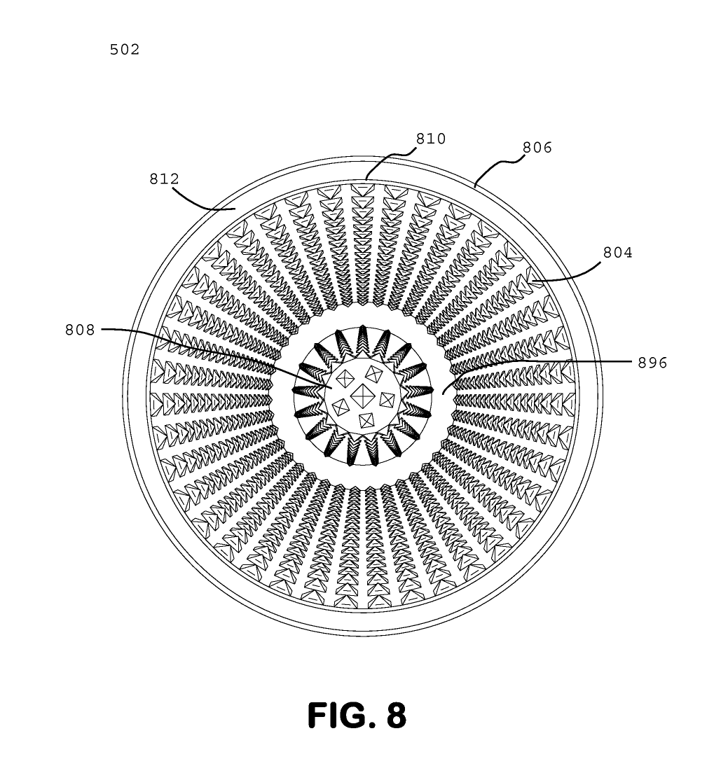

Turning to FIG. 8, an embodiment of a mixing device container 802 is shown in a top down view. The container 802 has a centrally located and substantially large protrusion 808 extending from the closed end 896 and may optionally be formed with the closed end 896 and the plurality of generally small or modest protrustions 804 lining the interior surface, including the centrally located substantially large protrusion. The internal features as described may be formed, as stated above, in an insert which is placed into the container 802 either before or after the container 802 is formed. In the figure, the plurality of generally small to modest protrusions 804 vary in size relative to the height in the container 802. The small to modestly sized protrusions may take shapes other than what is shown and may not necessarily be in an ordered fashion or each be of similar shape.

The protrusions shown in the figure appear to extend from the closed end up and proximal to the rim 806 terminating in an edge 810 that may or may not act in a sealing capacity. In one embodiment the insert material is formed from a hard type plastic, therefore the edge 810 of the insert would not suitably function as a seal. However, the edge may provide mechanical support for a softer and insertable seal as previously described, but not shown, such that the seal is adhered to the edge and/or the inner surface 812, or formed in place during manufacture. Alternatively, the edge 810 may be distal to the rim 806 sufficiently to provide clearance for an interference fit of a cap (not shown) and the container 802, as described above.

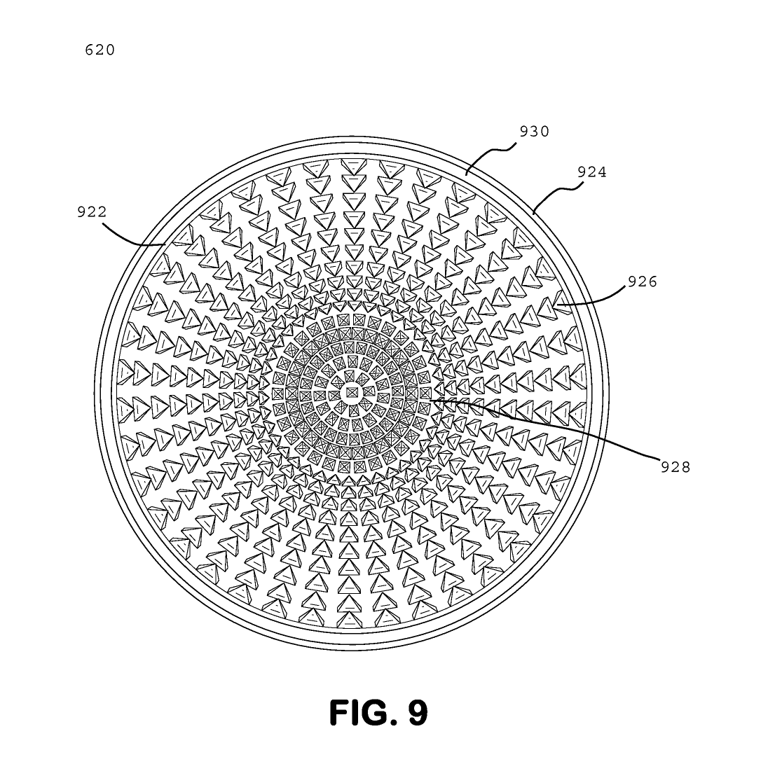

In FIG. 9, an embodiment of a mixing device cap 920 is shown in a bottom up view highlighting the cap cavity. The cap 920 has a closed end 928 and the plurality of generally small or modest protrusions 926 lining the interior surface, including the closed end 928. The internal features as described may be formed, as stated above, as an insert which is placed into the cap 920 either before or after the cap 920 is formed. In the figure, the plurality of generally small to modest protrusions 926 vary in size relative to the height and inner diameter of in the cap 920. The small to modestly sized protrusions 926 may take shapes other than what is shown and may not necessarily be in an ordered fashion or each be of similar shape.

The protrusions shown in the figure appear to extend from the closed end up and proximal to the rim 924 terminating in an edge 922 that may or may not act in a sealing capacity. In one embodiment the insert material is formed from a hard type plastic, therefore the edge 910 of the insert would not suitably function as a seal. However, the edge may provide mechanical support for a softer and insertable seal as previously described, but not shown, such that the seal is adhered to the edge and/or the inner surface 930, or formed in place during manufacture. Alternatively, the edge 922 of the insert may be sufficiently distal to the rim 924 to provide clearance for an interference fit of a container, such as the container 902, shown in FIG. 8, and described above.

### STATEMENT REGARDING PREFERRED EMBODIMENTS

While the invention has been described with respect to preferred embodiments, those skilled in the art will readily appreciate that various changes and/or modifications can be made to the invention without departing from the spirit or scope of the invention as defined by the appended claims. All documents cited herein are incorporated by reference herein where appropriate for teachings of additional or alternative details, features and/or technical background.

I claim:

1. A mixing device comprising:
a seperable upper portion having a closed end connected to an annular opening by a conical to nearly cylindrical side surface defining a cavity;
a lower portion having a closed end connected to an annular opening by a conical to nearly cylindrical side surface defining a cavity and configured to mateably seal to said upper portion generally about their annular openings, said lower portion comprising
a substantially large protrusion extending from said closed end into said lower portion cavity and operatively configured to impinge one or more ingredients added thereto.

2. The mixing device of claim 1, further comprising an ingredient facing surface having a plurality of generally small protrusions dispersed within each cavity.

3. The mixing device of claim 1, wherein the protrusion is an insert.

4. The mixing device of claim 2, wherein the substantially large protrusion and the plurality of generally small protrusions are formed on an insert, inserted into each cavity.

5. The mixing device of claim 1, wherein the upper portion comprises a protrusion extending from said closed end into said cavity and both the upper and lower protrusions are operatively configured to mutually impinge one or more ingredients when the upper portion and lower portion are joined.

6. The mixing device of claim 1, wherein the lower portion has a grip surround axially about the outer surface extending from proximal to the annular opening of the lower portion to the mid-section.

7. The mixing device of claim 1, wherein the upper portion comprises an opening diameter minimally larger than said lower portion, said upper portion mateably forming a seal by fitting over said lower portion

8. A method of preparing a concoction in a mixing device comprising:
adding ingredients to a lower portion of said mixing device, said lower portion having one or more protrusions;
joining a mating upper portion operatively forming a seal with said lower portion;
shaking said mixing device, impinging one or more of said ingredients on said one or more protrusions; and
imparting said at least a portion of said one or more of said ingredients into said concoction.

9. A mixing device comprising:
a seperable lower portion comprising a closed end connected to a rimmed opening by a conical to nearly cylindrical side surface defining a cavity,
said lower portion comprising a protrusion extending from said closed end into said lower portion cavity;
an upper portion comprising a closed end connected to a rimmed opening by a contoured conical side surface defining a cavity and configured to mateably seal with said rimmed opening of said lower portion,
said upper portion side surface extending distal to said closed end, beyond whereabout said upper and lower portions mateably seal, and having a side surface interior diameter minimally larger than said lower portion rimmed opening.

10. The mixing device of claim 9, further comprising an ingredient facing surface comprising a plurality of generally small protrusions dispersed within each cavity.

11. The mixing device of claim 9, wherein said plurality of generally small protrusions is formed by an insert, inserted or formed into each cavity.

12. The mixing device of claim 9, wherein the mixing device is a beverage mixing device.

13. The mixing device of claim 9, wherein the exterior surface of the upper portion closed end is relatively flat and the rim height relative to said a closed end is variable and periodic about the circumference.

14. The mixing device of claim 9, wherein the upper portion comprises a sealing member affixed to the interior surface of the upper portion and configured in size to mate with said rim of said lower portion.

15. The mixing device of claim 9, wherein the rim of the lower portion seals against the inner surface of the upper portion.

16. The mixing device of claim 9, further comprising a molded hand grip incorporated into said upper portion.

17. The mixing device of claim 11 wherein the rim of the lower portion seals against the edge of the insert of the upper portion.

18. The mixing device of claim 13, wherein the variable rim height is substantially sinusoidal.

19. The mixing device of claim 13, wherein said upper portion has a midsection with molded-in features substantially similar to that of the rim.

20. The mixing device of claim 13, wherein partially separated upper and lower portions reveal a generally triangulated opening from which the liquid portion of a prepared beverage is dispensed.
